(19) United States
(12) Patent Application Publication
(10) Pub. No.: US 2009/0152339 A1
(43) Pub. Date: Jun. 18, 2009

(54) METHOD AND APPARATUS FOR TAMPER PROOF ELECTRONIC VOTING WITH INTUITIVE USER INTERFACES

(76) Inventors: Richard Hawkins, Los Angeles, CA (US); Ping Shao, Los Angeles, CA (US)

Correspondence Address: MARC E. HANKIN, ESQ., 11414 THURSTON CIRCLE, LOS ANGELES, CA, 90049, US

(21) Appl. No.: 11/956,335

(22) Filed: Dec. 14, 2007

(51) Int. Cl. G07C 13/00

(52) U.S. Cl. 235/51

(57) ABSTRACT

A tamper proof electronic voting machine with intuitive user interfaces.

### CROSS-REFERENCE TO PRIORITY APPLICATION

This application relies for priority on the filing date, Dec. 13, 2006, of U.S. Provisional Application No. 60/874,668, entitled “Method and Apparatus for Tamper Proof Electronic Voting with Intuitive User Interfaces”, to inventors Richard Hawkins and Ping Shao, all the contents of which are incorporated herein by this reference.

### FIELD OF INVENTION

This invention relates to the field of electronic voting, and especially to a method and apparatus for tamper proof electronic voting with intuitive user interfaces.

### BACKGROUND

Electronic voting machines are known in the art. In the United States, ever since problems with mechanical voting arose during the hotly contested election of 2000, many states have been replacing their systems with new electronic voting systems. However, many of the new systems that were developed in response to that election have convinced both expert critics and much of the voting public that they are even less trustworthy and more dangerous to democracy than the system that they were intended to replace. News and allegations of tampering, fraud, and manipulation have surfaced in many national and local elections since 2000.

In addition to problems encountered in real life practices, these new electronic voting systems have been shown by professional and academic experts to be susceptible to hacking, fraud and manipulation. Worse yet, many voters and poll workers have been confused by their complex interfaces, and many such systems require experienced technicians to reboot and restart them in case of failures. As such, these systems work against the goals of elections that every eligible voter, regardless of any physical disability, should be able to vote privately and independently, that each vote should be counted, and that the final results should be free from suspicion of corrupt manipulation or fraud.

The results of the 2000 election were delayed for weeks by the difficulty of agreeing on the interpretation of dented or partially punched out “chads” from the Votomatic machines used in Florida. These Votomatic mechanical machines were introduced by IBM in the early 1960s and by 2000 were in widespread use throughout the United States.

Some problems had been noted with these machines over the years, but the litigation and turmoil of 2000 highlighted their deficiencies. Over the years, the faults with which the system was charged, in addition to the difficulty of punching out chads, were that, if the ballot card was not of an exact length it could be misaligned in the ballot holder and cause the stylus to make an unintended vote. It was also said that, since there were only numbers and no names on the ballot card, voters could not be sure for whom they had voted. Rather than remedying these problems, the “Help Americans Vote Act” passed in the wake of the 2000 election banned the further use of the Votomatic machines in U.S. elections.

However, because of the many decades of use, the Votomatic system was familiar to many voters and local poll workers. The ban of this system resulted in confusion of many whom have grown accustomed to the Votomatic format, and the new electronic systems have not replicated the advantages and features of the Votomatic. Combined with the allegations of manipulation and fraud of new electronic systems, voter confidence has been shaken. Hence what is needed is an electronic voting system that is tamper proof and provides intuitive, simple and familiar interfaces to all voters, including voters with disabilities.

### SUMMARY OF THE INVENTION

The present invention takes a novel and different approach to the current problems with voting equipment. Rather than completely discarding the advantages of the Votomatic system that uses compact numerical ballot cards, the present invention is an electronic voting apparatus that builds upon that system to provide a system that is much more reliable, verifiable, versatile and transparent than any of the electronic voting machines now on the market. It is also designed to be more accessible and easier to use for the visually impaired and for people with disabilities than any of the electronic voting machines in the art. In short, the present invention retains the advantages of the Votomatic system, combines them with features of the electronic systems, and adds additional security measures to counter tampering and manipulation.

One embodiment of the present invention is a tamper proof electronic voting apparatus that provides intuitive interfaces for the voter. The invention addresses all of the following long-felt needs in the area of voting machines:

### Improving the Shortcomings of the Votomatic System While Retaining the Familiar Interface

The present invention retains many features of the Votomatic system, including the familiar user interface. At the same time the present invention remedies the previous shortcomings of the Votomatic system as follow:

### Ballot Card Sensor

First, one embodiment of the present invention contains a sensor in the ballot holder that ensures that the ballot card is in the correct position. If the ballot card is not in the correct position, Le., properly aligned, the voter cannot start the voting. In the original Votomatic system, variation in the length of the ballot cards would often confuse voters and cause them to punch or mark incorrect spots, resulting in either overvoting or undervoting.

### Elimintation of Chads

Second, the difficulty of punching out chads is eliminated by the use of a solid, ink-marked ballot card. In embodiments of the present invention, voters use a probe to mark the ballot card and the probe ejects a proper amount of ink to mark the card.

### Visual and Audio Cues for Voters

Third, in the present invention, besides voting with compact numerical ballot cards that are familiar, voters are informed at every step of the way, both on a computer screen and by voice, in their chosen language, before and after each vote, of the name and number of the candidate on whom they are voting. Hence, the confusion and guesswork in the original Votomatic system over what numbers to choose for a particular candidate are eliminated.

### Confirmation of Completed Votes

Unlike many electronic voting systems currently in the art, completed votes are shown on the screen and heard by voice. Before final confirmation, the votes can be checked on the screen, by voice and by a list printed on paper.

### Probe Based Voting

The original Votomatic ballot holder presents a grid consisting of series of holes. Each hole is a voting point, which can represent a vote for a particular candidate or proposition. One embodiment of the present invention comprises of a special probe that a voter uses to mark the compact numerical ballot card situated under an electronic grid of holes with sensors. When the probe is inserted in a hole that correspond to a number on the numerical ballot card, a sensor is triggered and the name and number of a candidate is given on screen and on earphones.

When the probe is pushed down in the hole a vote is recorded. A list of the votes is kept on screen, repeated by voice and printed out on paper for the voter to review before making a final confirmation. The ink-based electronic voting probe is more fully described in U.S. Pat. No. 7,007,842, issued Mar. 7, 2006 to the same named inventors, and U.S. patent application Ser. No. 11/367,658, filed Mar. 4, 2006, by the same named inventors. Both U.S. Pat. No. 7,007,842 and U.S. patent application Ser. No. 11/367,658 are hereby fully incorporated by reference.

### Button Based Voting

Another embodiment of the present invention makes use of the same electronic grid of voting points, but eliminates both the holes with sensors and the probe. In this embodiment, voters can control their voting process by the use of buttons. This method can make voting very fast and easy. It also enables the visually impaired or persons with other disabilities to use only a single button, or other special device, to vote by responding to the names and numbers of the candidates, either by responding to the information on a screen or given audibly and repeatedly through an earphone.

### An Accessible System

The present invention has been developed to serve both able-bodied voters and voters with disabilities. It is a system that is easy for all to use. The electronic systems that are now available have presented major difficulties, dangers and problems, both for able-bodied voters and voters with disabilities. Currently, many electronic systems use touch screen inputs that are hard to understand and difficult to use for many voters, especially voters with dexterity problems. In contrast, the button-based voting used in the present invention has been especially endorsed by disability rights groups for persons with disabilities.

### A Transparent and Verifiable Voting System

The present invention is transparent and verifiable, and free from both technical error and suspicion of fraud and corruption. Many electronic voting systems in the art only store results in a removable medium such as an IC card and nowhere else. They also do not provide cross-checking mechanisms and are susceptible to virus and hacking codes on the IC cards (or other removable media) read by their systems.

### Final Tally Screen

In one embodiment of the present invention, a final tally screen displays the record of the actual number of votes cast by buttons. Since the final tally screen can only reflect the number of times the buttons are pushed for a given candidate or proposition, it is not susceptible to electronic hacking and manipulation. This final tally screen can be used to cross-check the vote results stored in the removable medium, e.g., the IC card. Election monitors from different political parties can check the final tally screen and perform their independent audit. In one embodiment, the final tally screen is stored on the hard drive that is secured within the system.

### Write-Only Medial Drives

In another embodiment, the removable media drive is programmed to write-only so that nothing programmed on a medium inserted into the voting apparatus is read. Therefore, the present invention is impervious to virus and hacking codes programmed on the removable media such as an IC card.

### Internal Programming

In one embodiment of the invention, the input program, which is used to input the balloting material (e.g. candidate names, races) onto a medium that governs voting, specifically limits the number of votes allowed for each race. Hence, the programming blocks voters from overvotin9 or giving extra votes to a chosen candidate.

Combined with the aforementioned write-only media storage feature, the only way to gain access to the voting apparatus of the present invention is to access the input program. Since this program remains at the official voting headquarters, and does not go out to the precincts, this provides an additional layer of security.

Unlike many electronic voting machines in the art that have failed the test devised by Princeton University, in which programmers are able to reprogram those machines in the field, those who gain physical access into the actual voting machines of the present invention in the field cannot reprogram them.

### Additional Cross-Check Mechanisms

Another embodiment of the invention displays a printer paper record back to the voter as the voter is voting. Another embodiment of the invention generates actual paper ballots that can be optically scanned or manually counted. With these additional methods, vote results are recorded and displayed in multiple channels and methods and, as such, they provide cross-checks and additional assurance that the results recorded are indeed reflective of the actual will of the voters.

The present invention is the only system specifically designed to deal with all of the aforementioned problems and to fill the long felt need for the transparent, accessible and verifiable voting system that has not been designed and made available before.

### Overview of the System

The apparatus allows voter to vote by simply selecting candidates through an interface that comprises of a large screen and several buttons. The screen is divided into two halves, with one half displaying the current ballot item and the other displaying the cumulative results that have been input by the voter. As such, the display informs the voter of all the votes that have been cast along the way, and allows the voter to return to previous items that he or she wished to correct. The button-based interface makes voting simple and intuitive, and allows voters with disabilities to cast their votes without hindrance.

In one embodiment of the present invention, election information is programmed onto an optical disc. The voting apparatus includes an optical disc reader that reads the optical disc and displays the election information. The election information contains, for example, names of candidates, ballot item numbers, proposition items, and any other relevant election materials and instructions for the voters. The optical disc (Le. CD or DVD or other optical media) may be programmed at the election headquarters, and the disc may contain election information in multiple languages, so that the display can display the information in the various languages as required in the local jurisdiction. In addition, the optical disc may contain the audio data representation of the election information, and audio can be in multiple languages. In an audio mode, the voting apparatus will read the audio data and read out audibly the election information, via an earpiece, to those voters who choose to vote in the audio mode. In addition, when a printout of the results is printed on the printer (for the purposes of giving voters a chance to confirm their votes), an audio program reads the printed results to the visually impaired as well.

In addition, the present invention comprises a language selection mechanism that allows voting to be conducted in one of several languages. For example, the optical disc can be programmed to contain lists of candidates in Spanish so that the information is displayed and announced in the Spanish language during the voting process. Multiple languages can be recorded and a selection mechanism allows the voter to choose the language at the time of voting.

One embodiment of the system can also freeze an individual machine when a voter has confirmed the ballot, in order to forestall any attempt to vote again. Once frozen, the voting machine will remain inactive until a poll worker reactivates it for the next voter. The reactivating device can also serve to count the number of people who have voted.

### Embodiment with a Probe-Based and Button-Based Input

Another embodiment of the present invention includes an optional inkbased electronic voting component that generates a conventional ink-marked paper ballot for every voter. This component of the voting apparatus presents a familiar interface to voters who have used an ink-based voting system. Instead of a pen, this embodiment of the present invention provides an electronic probe to the voter for marking the paper ballot on an input board. The voter marks the ballot with the probe as he/she would with a conventional ink-based system, where a paper ballot is inserted underneath an input board with a gird of circular holes that match the printed circles on the ballot. The probe has a mechanism for electronically recording votes as it interacts with the holes on the input board and a mechanism for regulated ink-release to prevent' mistakes. The ink-based electronic voting component is more fully described in U.S. Pat. No. 7,007,842, issued Mar. 7, 2006 to the same named inventors, and U.S. patent application Ser. No. 11/367,658, filed Mar. 4, 2006, by the same named inventors. Both U.S. Pat. No. 7,007,842 and U.S. patent application Ser. No. 11/367,658 are hereby fully incorporated by reference.

In the embodiment with the ink-based electronic voting component, the display is modified to accommodate input from both the electronic probe and the input board. In another embodiment, the display can accommodate input from the electronic probe as well as the input panel, which comprises of several buttons. Therefore, the election officials can choose to have the voters vote by touching the buttons or by marking a paper ballot with an ink-regulated probe. In yet another embodiment, the system also provides the opportunity for voters to mark the numbered ballot card, or alternate printed ballot, without using the machine, and then have their ballots scanned and counted by a special scanner.

If the probe-based component is used, the display will choices on a display screen and allow voter to use the probe to make selection on a paper ballot situated underneath the surface of an input board electrically connected to a computer. A vote is cast when a user depresses the probe on the ballot at a designated input point. The electronic interaction between the probe and the input board generates an electric vote signal for recording and causes ink to be released from inside the probe to mark a designated corresponding spot on the paper ballot card. As such, votes are electronically recorded for fast tabulation while actual paper ballots are generated for possible manual recounts and/or optical scanner recounts to safeguard against computer errors and tampering. Furthermore, the voting apparatus has a built-in mechanism to prevent undervoting and overvoting and thus improve the number of valid votes actually recorded. For example, if the voter attempts to overvote (vote again for the same selection), the probe will be blocked from releasing ink, the voter will be advised, either audibly or through a display indication, and no vote will be recorded.

Alternatively a voter can input his or her votes using the buttons on the input panel and following along with the instruction and information provided on the display of the voting apparatus. In one embodiment, when the electronic probe head is inserted into an input point on the input board and creates electrical contact, the voting apparatus automatically provides voting information on the LCD screen and/or by voice. Thus, for example, a voter can insert the probe into a first input point and see candidate 1's name displayed on screen and/or announced via the earpiece. Then the voter can move the probe and insert it into a second input point below to see candidate 2's name displayed on screen and/or announced and so on. The voter is both visually and audibly alerted to the choice he/she is about to make and advised in case of trying to make an invalid voter.

### Meeting Challenging Electronic Voting Requirements

The embodiment with the probe-based input is uniquely equipped to meet legal requirements that demand computerized systems generate paper records of the actual votes. Since each voter generates a conventional ink-based ballot, the ballots collected for the entire election can be recounted by manual or optical scanner means. Besides meeting this requirement, the present invention also offers a voting interface that is similar to the mechanical ink-based systems or the Votomatic systems familiar to most voters and polling workers and thus reduces error and frustration.

The button-based interface provides a simple and intuitive interface also. In conjunction with the display, the button interface eliminates overvotes and reduces undervotes. Also, since the voting apparatus only accepts voting buttons as input, there is little risk of tampering and code alteration. Also, in the button-based embodiment a printer provides a print-out of the votes cast, and two records of the votes—one on an IC card to be sent back for counting, and another on the local hard disc of the voting apparatus—providing additional safeguards and crosschecks to ensure the accuracy of the voting results.

Finally, as one embodiment of the invention is implemented in open source platform of the Unux operating system, the voting apparatus enhances transparency and promotes public confidence in the voting process.

### Optional Configurations

A number of optional configurations can be made in the present invention. For example, an optional printer can be attached to provide a paper version of the vote results for an additional cross-check to ensure an even higher degree of accuracy and tamper-resistance. For enhanced accessibility, a keypad can be used as a voting input device in lieu of or in conjunction with the probe and input board. A Sound Equalization device can also be attached as an aid for those with severe hearing problems.

### BRIEF DESCRIPTION OF THE DRAWINGS

FIG. 1 is a block diagram overview of the present invention

FIG. 2 is a picture of the display and input interface components according to an embodiment of the present invention.

FIG. 3 is a diagram showing an embodiment of the present invention.

FIG. 4 is a diagram showing an embodiment of the present invention.

FIG. 5 is a diagram showing an embodiment of the present invention.

FIG. 6 is a diagram showing an embodiment of the present invention.

FIG. 7 is a diagram showing an embodiment of the present invention.

FIG. 8 is a diagram showing an embodiment of the present invention.

### DETAILED DESCRIPTION ON THE DRAWINGS

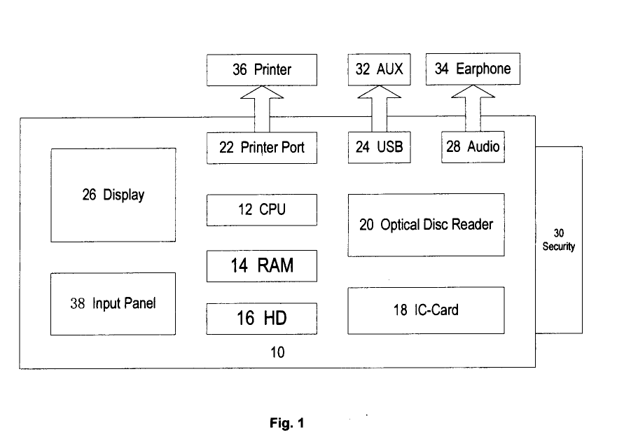

FIG. 1 is a block diagram that illustrates an embodiment of the present invention. Voting apparatus 10 is comprised of several components shown. Central Processing Unit (CPU) 12 in one embodiment is a CPU embedded in a computer motherboard. CPU 12 works in conjunction with Random Access Memory (RAM) 14 and Hard Drive (HD) 16. In one embodiment, a Unux operating system is stored in Hard Drive 16 and is loaded, upon power-up into RAM 14 and CPU 12 for processing. It can be appreciated by those skilled in the arts that CPU 12 and RAM 14 can be implemented various components readily available in the computer marketplace, including but not limited to Intel-based CPU and motherboard and DRAM and/or SDRAM.

In one embodiment, after the initial operating system starts, Optical Disc Drive 20 reads an optical disc that contains election information. The information is loaded into CPU 12. The information is processed in CPU and displayed to the voter in Display 26. As the voter casts his or her vote, the vote results are displayed back to the voter in Display 26. The voter votes using Input Panel 20. In one embodiment, Input Panel 38 comprises of several buttons by which a voter can interact with Voting Apparatus 10.

Once the voter confirms his or her votes, Voting Apparatus 10 records the results on an IC card within IC card drive 18. For security reasons, IC Card Drive 18 is a write-only drive in one embodiment. In another embodiment, Security Lock 30 is used to prevent unauthorized access to the reading and writing of IC Card Drive 18 and Optical Disc Drive 20. Authorized poll workers can use the key to initiate writing the IC Card Drive 18 and Disc Drive 20 during the normal course of the operation of the apparatus. Unauthorized intrusions are recorded with time stamps in Hard Drive 16.

Printer port 22 sends out the voting results to Printer 36 attached to printer port, so that the electronic results can be transferred to a paper record. USB port 24 allows for the connection of a keypad an additional input button. Audio port 28 provides audio signal for voters who wish to vote in the audio-only or audio-assisted voting mode. In one embodiment, Earphone 34 is connected to Audio port 28 and the voter can use Earphone 34 to hear the ballot items and instructions read out loud. Also, different audio signals can be filtered at different frequencies so that some deaf voters may be able to distinguish the different inputs that the voter is making by the different frequencies generated by the voting apparatus 10. For example, the voting apparatus may make different sounds when different inputs are selected, e.g., one sound at one frequency for completing a vote, and another sound at another frequency for canceling a vote, etc. Thus the audio can enhance the voter's sense of how the voting apparatus is responding to the voter's input.

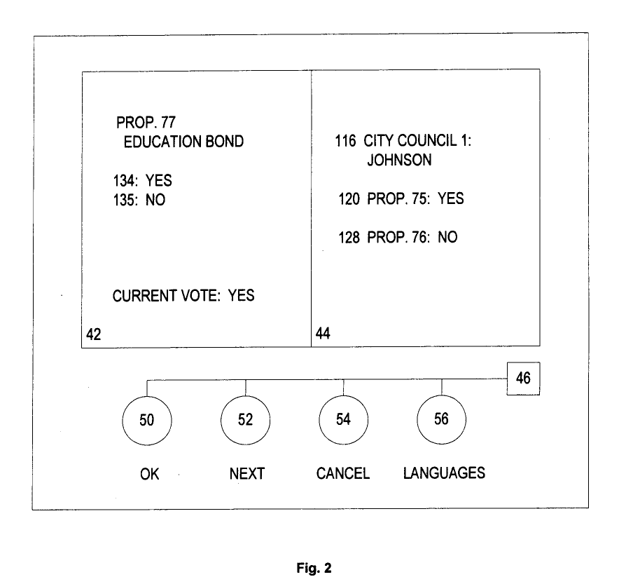

FIG. 2 shows a picture of the display in an embodiment of the invention. When the voting first begins, a voter can choose to vote in alternative languages by pressing LANGUAGES 56. Otherwise the voting apparatus defaults to English. In FIG. 2, Display 40 is comprised of Display 42 and Display 44. Display 42 displays the current item being voted on. In the example shown in FIG. 2, a proposition is being voted on. At the bottom of Display 42 the current choice of the voter is displayed. The voter can use NEXT button 52 to cycle through the choices of the current item being voted on. In this example, when the current item, the ballot proposition, is first displayed, the voter presses NEXT button 52 to get to the first choice, which in this case is the “YES” choice. If the voter presses NEXT button 52 once more, the current choice at the bottom of Display 42 will change to the next choice, which is the “NO” choice. Thus, the voter can press NEXT button 52 to cycle through the choices for the particular ballot item. In one embodiment, after reaching the last choice, pressing the NEXT button 52 will again return to the first choice on the list.

Once the voter is satisfied with the current choice, the voter can press OK button 50 on Input Panel 46 to confirm the choice. The choice will then be transferred to Display 44. The choice will be added a cumulative list of all previous cast votes, as shown by way of example in FIG. 2. Display 44 shows that three votes have been cast so far, showing that the voter has voted for “JOHNSON” in the City Council race, and” YES” for Proposition 75 and “NO” for Proposition 76. In one embodiment, the numbers displayed next to the choices correspond to the ballot numbers in a conventional paper ballot. At any point of the voting process, if the voter is not satisfied with his or her previous choices, the voter can press CANCEL Button 54 to return to the last ballot item. Hence, in the example shown in FIG. 2, if a voter presses CANCEL button 54, Display 42 will return to Proposition 76 and allows the voter to change his or her vote. And when the voter confirms his or her vote by pressing OK Button 50, Display 42 will return to Proposition 77 and the voter will have the chance to vote on that item. Display 44 will keep track of votes cast.

### Button-Based Interface

The simple yet intuitive button-based interface of the voting apparatus allows the voter to control the voting apparatus by pressing few simple buttons. The few buttons make the voting apparatus very easy to use and reduce voter confusion. Using buttons as input also reduce potential problems many touch-screen electronic voting apparatus. For example, in a touch-screen system, many voters may have difficulty realizing just when they have made an input. Also sometimes, the length of the fingernails of the voters may make voting difficult on the touch-screen system. Finally, some people with disabilities may not have the dexterity to vote on a touch-screen system.

In contrast, the button-based input as used in the current invention gives most voters a simple and familiar interface, and thus reducing confusion and error. Moreover, people with disabilities will have little difficulty pushing the large buttons. Indeed, the entire voting process can be completed by using as few as three or even two buttons. In one embodiment, the voting apparatus makes a sound as each button in the input panel is pressed. The sound can be configured so that the voting apparatus makes a different sound for each button. In one embodiment, each button has different texture or Braille writing near it. These features are especially useful for voters with visual impairments, who may have to use the audio only option. These voters can vote without the aid of the display.

Besides the simple and intuitive interface, the buttons and display also serve to reject overvotes. Therefore if the user presses OK button 50 to vote again for the same ballot item, the display will indicate an error and reject the new vote. In addition, the button-based system will warn of undervotes when the voter presses OK button 50 without first selecting a candidate through the use of NEXT button 52. With these features, the button-based voting apparatus reduces voter errors and inspires voter's confidence.

In addition, the voting apparatus accommodates for various types of voting, including straight-ticket voting, in which a voter is allowed to select, by the push of one button, all items related to a particular party straight down the ticket. The voting apparatus can also handle ranked choice voting, in which case the voter will cycle through the candidates several times using NEXT button 52 and OK button 50 to cast multiple votes for a single items.

### Probe-Based Voting Embodiment

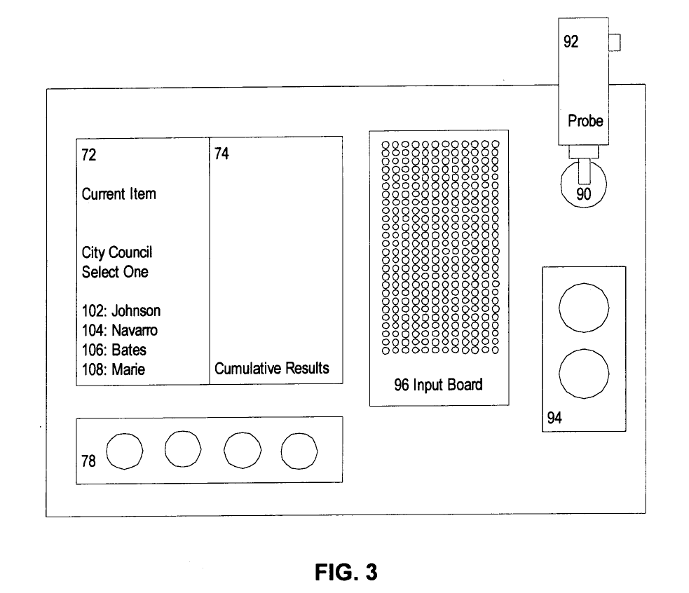

Another embodiment of the present invention includes an optional ink-based electronic voting component that generates a conventional ink-marked paper ballot for every voter. This component of the voting apparatus also presents a familiar interface to voters, especially those who have used an inkbased voting system. This embodiment is shown in FIG. 3. Instead of a pen, the present invention provides an Electronic Probe 92 to the voter for marking the ballot. The voter marks the ballot with the probe as he/she would with a conventional ink-based system. A paper ballot is situated under Input Board 96, whereby Probe 92 makes electrical connection with the Input Board 96 in the gird of circular holes on Input Board as the voter votes. Each hole represents a choice, much like each circle printed on a conventional paper ballot represents a ballot item choice. The voter would look at the numbers displayed in Display 72 for the current ballot item. For example, FIG. 3 shows that Display 72 is displaying a city council race with four candidates, each with a different ballot item number. If a voter wishes to vote for candidate “BATES” for example, the voter would find the hole marked “106” on Input Board 96 (the numbers for the holes are not shown in FIG. 3) and insert Probe 92 into that hole. Probe 92 would make contact with electrical connections embedded within Input Board 96, and Probe 92 would also inject quick dry ink onto the paper ballot situated underneath Input Board 96. The paper ballot would then be marked in the appropriate place, in this case, item “106.” An electronic signal would be recorded to register that the voter has voted for the candidate “BATES” in ballot item “106.” Therefore, at the end of the voting process the voting apparatus will have an electronic record of the votes cast that mirrors the ink blots on the paper ballot.

In one embodiment, a voter begins voting by taking Probe 92 out of Probe Holder 90, and the voter ends the voting when he or she reinserts Probe 92 back into Probe Holder 90.

The advantage in this embodiment is that the probe has mechanism for electronically recording votes and mechanism for regulated ink-release to prevent mistakes. The ink-based electronic voting component is more fully described in U.S. Pat. No. 7,007,842, issued Mar. 7, 2006 to the same named inventors, and U.S. patent application Ser. No. 11/367,658, filed Mar. 4, 2006, by the same named inventors. Both U.S. Pat. No. 7,007,842 and U.S. patent application Ser. No. 11/367,658 are hereby fully incorporated by reference.

### Other Embodiments

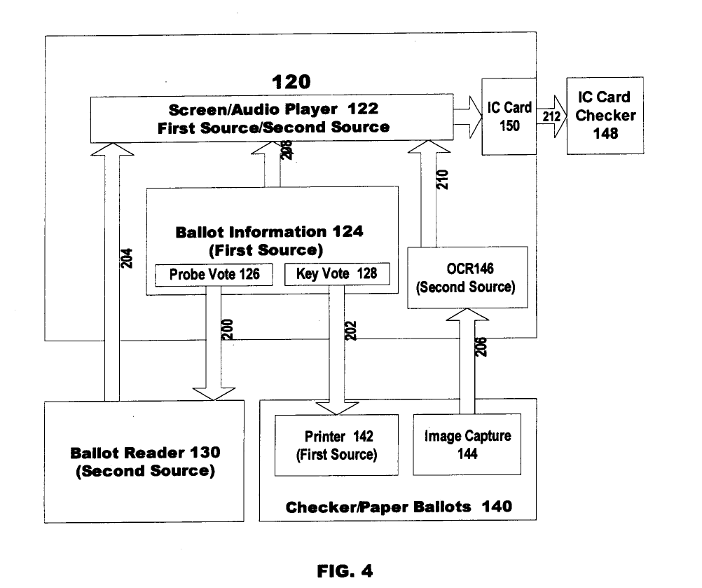

FIG. 4 shows another embodiment of the present invention. Voting Apparatus 120 is comprised of Ballot Information 124, Screen/Audio Player 122, OCR 146, and IC Card 150. Furthermore, Ballot Information 124 is comprised of Probe Vote 126 and Key Vote 128.

In one embodiment, there is a choice of input between Probe Vote 126 and Key Vote 128. When a voter votes with Probe Vote 126 (voting with an electronic probe marking a paper ballot on an electronically connected input board with sensors as described above), in step 200 the votes are recorded on a paper ballot card and the paper ballot card is sent to Ballot Reader 130. An electronic tally of the vote results is automatically recorded with Probe Vote 126. Since this is the first instance of a recorded input by the user, this is indicated by the label “First Source” in the figure. In step 208, Ballot Information 124 is sent to Screen/Audio Player 122 for display and playback during voting to help guide the voter along.

Ballot Reader 130 reads the paper ballot generated by the voter through using Prove Vote 126 and tallies the votes electronically. Since this is a second instance of recorded input, this is indicated in the figure by the label “Second Source”. Then in step 204 the results are fed back to Screen/Audio Player 122 so that the voter can get a visual or audible feedback on what he or she has voted. More importantly, results are announced audibly to voters with visual impairments, so that they have the same opportunity to check their printed ballots as sighted voters do. This is a feature not found in any voting machines in the art. Ballot 130 could be used in any recount, and this is needed to counter any potential for reprogramming or manipulation of the computer program within the voting apparatus.

When a voter votes with Key Vote 128 (button-based voting as described in FIGS. 2-3), in step 202 the vote results are sent to Checker/Paper Ballots 140, which is comprised of Printer 142 and Image Capture 144. Also, as with Probe Voting, in step 208, Ballot Information 124 is sent to Screen/Audio Player 122 for display and playback during voting to help guide the voter along. Checker 140 checks for errors such as overvotes or undervotes. In other situations, the voter may want to be sure that the vote is recorded for the candidate that they have chosen. This is to counter the problem that sometimes touch-screen based systems flip votes.

In step 202 the vote results are printed on Printer 142. The printed records allow a voter to visually confirm what votes have been cast. Since this is the first instance of a recorded input by the user, this is indicated by the label “First Source” in the figure. In addition, Printer 142 provides a paper trail of what has been input through Key Vote 128.

Of particular importance is that the printed results are captured in Image Capture 144. This is a security feature to ensure that what the voter sees on the printout is captured electronically. The captured image is then sent in step 206 through OCR 146, and later, in step 210, the image is sent to be displayed in Screen/Audio Player 122 for the voter's confirmation. In one embodiment, the image is converted to text with OCR and converted to audio data so the vote results are read back to the voter for confirmation. After the voter confirms the information, it is sent to IC Card 150, which stores the image of the printout. Since this is the second instance of a recorded input by the user, this is indicated by the label “Second Source” in the figure.

In one embodiment the printout image is then sent to Screen/Audio Player 122 for display, or more importantly, in the case of visually impaired voters, for audible announcement of text (voter's choices) on the printed image. This is so that voters with visual impairments can receive an audible confirmation of the votes they have cast. Finally, the captured image of the printout is sent to IC Card Checker 148 for storage in step 212.

As described, Voting Apparatus 120 has two sources of recording per each type of voting, whether by Probe Vote 126 or Key Vote 128. The two sources, labeled First Source and Second Source, combined with visual and audible feedback provided by Screen/Audio Player 122, work together to give additional safeguards against tampering, ensure that the voters are well-informed as to the what they have voted and that votes are accurately recorded. The multiple sources approach allows for cross-checking against errors and tampering and increases voter confidence in the system.

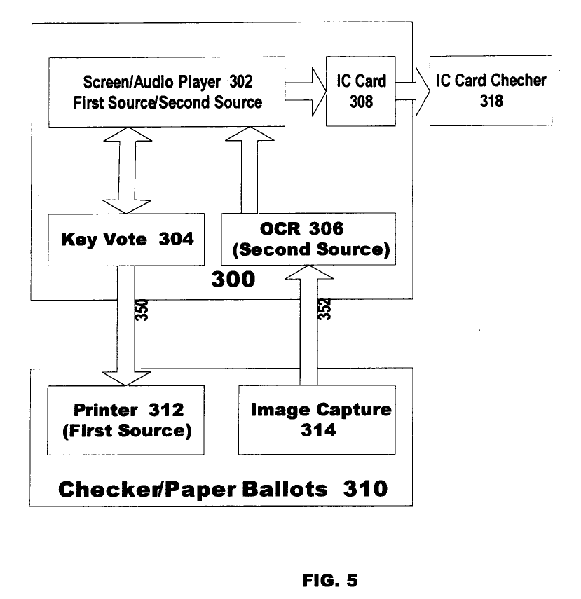

FIG. 5 shows another embodiment of the present invention. This figure depicts a similar embodiment to that shown in FIG. 4, but describes a similar process for Key Voting. Voting apparatus 300 is comprised of Key Vote 304, Screen/Audio Player 302, and OCR IC Card 306. When a voter votes with Key Vote 304 (button-based voting as described in FIGS. 2-3), in step 350 the vote results are sent to Checker/Paper Ballots 310, which is comprised of Printer 312 and Image Capture 314. In step 350 the vote results are printed on Printer 312. The printed records allow a voter to visually confirm what votes have been cast. Since this is the first instance of a recorded input by the user, this is indicated by the label “First Source” in the figure. In addition, the printer provides a paper trail of what has been input through the Key Vote 304.

The printed results are then captured in Image Capture 314. This is a security feature to ensure that what the voter sees on the printout is captured electronically. The captured image is then sent in step 352 to OCR 306, which stores the image of the printout in IC Card 308. At the same time the printed results are converted to text in OCR 306 and the converted text is sent to Audio Player 302 to be read back to the user. Alternatively, the captured image is sent back to be displayed on Screen 302. Since this is the second instance of a recorded input by the user, this is indicated by the label “Second Source” in the figure. IC Card Checker 318 checks for errors (e.g. overvotes or undervotes) in IC Card 308.

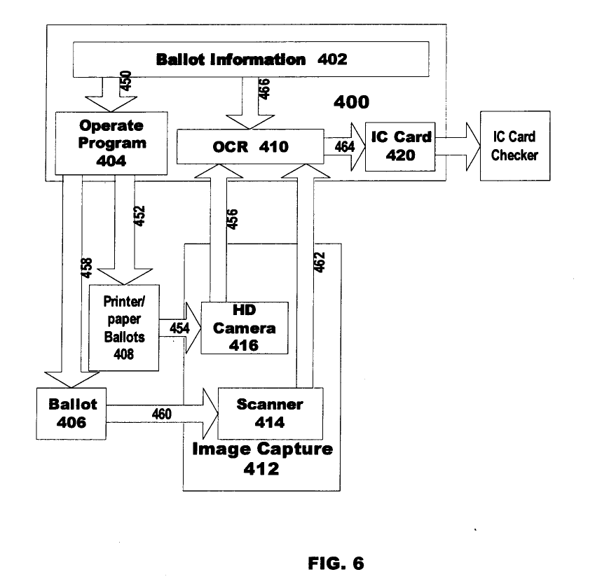

FIG. 6 depicts an additional view of the embodiment depicted in FIG. 4, but it shows two alternative methods of image capture, by camera or scanner. Voting apparatus 400 is comprised of Election Information 402, Operate Program 404, OCR 410, and IC Card 420. Voting apparatus 400 works in conjunction with Image Capture 412 to record votes.

In one embodiment, in step 450, Election Information 402 is input into Operate Program 404 through an input program. The input program is used at election headquarters to install all of the audio and visual information for each election. The program also installs commands into Operate Program 404 that govern the voting apparatus's reaction to the commands entered by the voter with the probe or buttons when certain candidate names are displayed. In one embodiment, the Operate Program 404 reads election materials programmed in a hard drive within the apparatus so that voters can follow along with visual display or audible instruction during the probe or key voting.

When a voter votes with a probe in Operate Program 404, the voter generates a paper Ballot 406 in step 458, and then in step 460, Ballot 406 is sent to Scanner 414 within Image Capture 412. Scanner 414 scans the ballot and sends the digital image file in step 462 to OCR 410. Scanner 414 scans the ballot to store it into an image file as well as converts the marks into election voting records. In one embodiment, OCR 410 converts the image file to text for audible read back to the voter. In another embodiment, OCR 410 sends the image file to IC Card 420 for storage in step 464.

When a voter votes with a button-based (key) voting in Operate Program 404, the votes that are captured electronically through the input are sent in step 452 to Printer 408. Printer 408 then prints out a paper ballot similar to that generated by probed based voting. In another embodiment printer 408 simply prints a paper record of the votes recorded. In step 454, Ballot 408 or a printout of the votes is captured by High Definition (HD) Camera 416. Then in step 456, HD Camera 416 sends the digital image file to OCR 410. In one embodiment, OCR 410 converts the image file to text for audible read back to the voter. In another embodiment, OCR 410 sends the image file in step 464 to IC Card 420 for storage.

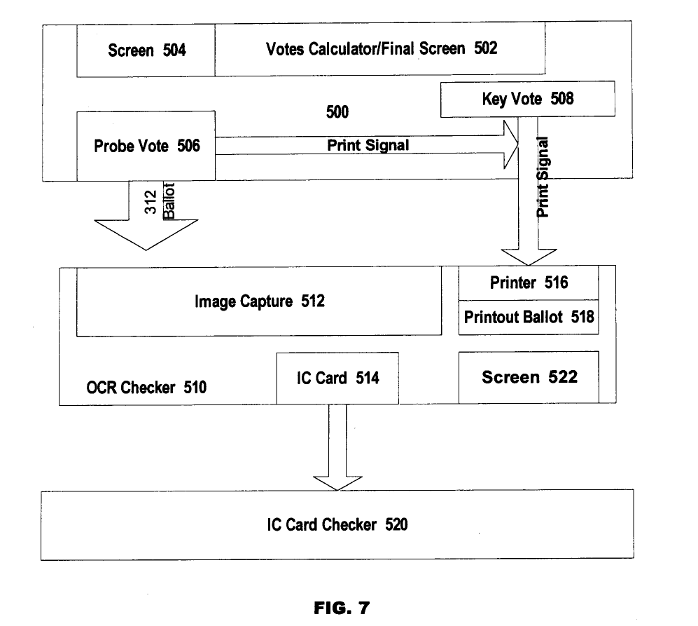

FIG. 7 depicts a similar embodiment as shown in FIG. 4, but FIG. 7 shows the use of two devices with two screens, instead of one integrated apparatus using one split screen. Voting apparatus 500 is comprised of Screen 504, Votes Calculator 502, Probe Vote 506, and Key Vote 508. Voting apparatus works in conjunction with OCR Checker 510 to record votes.

When a voter votes with Probe Vote 506, the voter generates a paper Ballot 312. Screen 504 displays the choices for each election item so the voter can follow along. At the same time during Prove Vote 506, a signal is sent to Printer 516, which prints the number and name of the candidate on a ballot. The same happens for button-based (key) voting, so that Key Vote 508 also sends a print signal to Printer 516, which in turn generates printed records of the votes. Votes Calculator/Final Screen 502 tallies both the probe and key vote electronically as the voter votes, so that as the end of the election there is an accurate tally of all vote results, which can then be displayed back in a “Final Screen” to election monitors.

Coming back to the voting process, once the voter completes voting, Paper Ballot 312 is sent OCR Checker 510. Image Capture 512 captures Paper Ballot 312 into an image file, scans the marks of the ballot and converts them into electronic voting records, and sends the results to IC Card 514. IC Card Checker 520 reads the results on IC Card 514 and displays on Screen 522. IC Card Checker 520 is also used after the election to read the results that the card contains. Unlike on other voting machines in the art, in one embodiment IC Card 514 in the present invention is not used for tallying the total votes. Because the IC Cards are a major means for tampering, the IC Cards are used only to record undervotes, retain ballot images, and keep a record of any intrusions. In another embodiment IC Card 514 retains ballot images as well as records of the votes from tabulated from scanning the marked ballots.

When a voter votes with Key Vote 508, or with Probe Vote 508, the results are sent to Printer 516 within OCR Checker 510. Printer 516 prints a Printout Ballot 518, and then Printout Ballot 518 is captured by Image Capture 512. The captured image is then stored in IC card 514. After the election, IC Card 514 can be checked by IC Card Checker 520. The results are displayed on Screen 522 for confirmation.

Therefore, with both Probe voting and Key voting, the results of the votes are displayed on screens 504 and 522 at the image capture stage so the voters can confirm the results of the votes recorded. If the results are accurate, these two screens will match. Hence they must match in order for the results to be accurate.

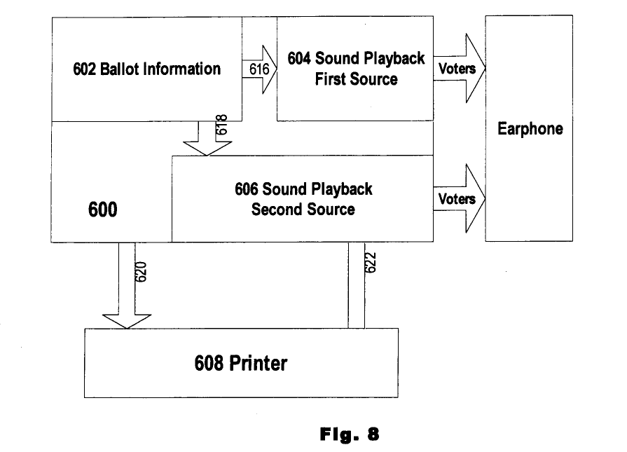

FIG. 8 shows another embodiment of the invention that reads back to voters with visual impairments the printed records of their votes. Voting apparatus 600 is comprised of Input Program 602, Sound Playback First Source 604, Sound Playback Second Source 606. Working in conjunction with Printer 608, they provide a way to audibly inform the voters with visual impairments of the choices the voters have made. Once input is collected through Input Program 602, in step 616, the results are sent to Sound Playback First Source 604 so that the results are read back to the voters. For example, a voter voting for a city council race will hear all the candidates for that race read to him as he or she uses a probe or key vote for voting. In step 618 the same audio information (e.g. candidate names are sent to Sound Playback Second Source 606. In one embodiment, for both instances of Sound Playback 604 and 606, audio is transmitted to the voters through an earphone as shown on FIG. 8.

Later on, once the voter completes voting, in step 620 the results are sent to Printer 620. The voting results are printed to create a paper record. Then in step 622 the printed results are sent to Sound Playback Second Source 606. The results are matched with the audio information sent during Step 618, and are read back there to the voter. Having multiple sources read back ensure that voters with hearing difficulties get two confirmations of their votes—one as they vote, and the other, a later on confirmation of all their voting results. This step is to create an equivalent step of confirmation—just as sighted voters can see the paper printout of their votes, voters with visual impairments can hear the results read back from the printed paper trail as well. This is a very important feature that is used to solve a problem that has caused much concern for visually impaired voters. It has been the subject of at least one lawsuit on their behalf. This embodiment of the present invention is the only voting apparatus that provides a solution to this problem.

### Input Program

One embodiment of the invention comprises of an input program that allows an election official to put in both sound and printed information for each election by ways of a computer keyboard. In one embodiment, it uses Microsoft Word for the input of sound and printed information. The Input Program can also accommodate foreign languages.

### Legal Requirements

The voting apparatus of the present invention is uniquely equipped to meet legal requirements that demand computerized systems generate paper records of the actual votes. In one embodiment with the probe-based electronic voting, since each voter generates a conventional ink-based ballot, the ballots collected for the entire election can be recounted by manual or optical scanner means. Besides meeting this requirement, the present invention also offers a voting interface that is similar to the ink-based systems familiar to most voters and polling workers and thus reduces error and frustration. In another embodiment, the voting apparatus presents a simple, straight-forward system that requires the voter to press two buttons to complete the entire voting process.

### Accessibility Features

The button-based embodiment of the voting apparatus of the present invention is especially accessible for voters with disabilities. Earphone 34 provides an audible interface to assist a visually-impaired voter in using the present invention. Voice instruction and verification are transmitted audibly to the voter via Earphone 34 and will guide the voter through the voting process step by step. Furthermore, an embodiment of the present invention allows for programming of voice instruction in multiple languages. In one embodiment, English is the default language and the voter can select a language using a language selection key (LANGUAGES button 56 in FIG. 2). These options eliminate the need for purchasing additional voting equipments for the visually impaired or foreign-language voters.

### Write-In Votes

In one embodiment, when voters select “I have a write-in vote,” which is an option that is displayed when write-in is allowed for a race, a 28-character bar will appear at the bottom of the screen including the 26 letters of the alphabet in order, from “A” to “Z”, “Space”, and “Over”. In this embodiment, the four buttons below the screen are used to select and control the letters. The UP arrow is used to move the letter selector ahead, one letter at a time, the DOWN arrow, moves the selector back through the alphabet. Pressing the OK button selects a letter and shows it on the screen to spell a word. Pressing the CANCEL button once will delete one letter. Pressing it twice will cancel all the previous letters, and allows the voter to re-write the entry. When the voter has finished the spelling the selection, pressing OK will record the write-in vote. The voter can then continue voting on other races.

For voters with visual impairments, a voice will read the letters in sequence until the voter selects a letter. Pressing the. UP button repeatedly will allow the voter to skip through the alphabet at a faster pace. The voice reading will be repeated until the spelling is complete. Then the name of the write-in candidate will be read back, letter by letter, for confirmation.

### Preventing Unintentional Undervotes

Every election section provides an opportunity to vote on one or more choices. If so desired, after each section, the voter can indicate a desire to abstain from one or more votes. In the present invention, a voter cannot proceed to the next voting section or remove the ballot card from the election box unit until he/she registers the decision to abstain on the current selection. The machine will keep a record of the number of votes from which the voter has abstained. Also, in one embodiment with either the probe-based or button-based voting, a warning is displayed on-screen in the event of an undervote.

### Preventing Overvotes

In one embodiment, the electromagnetism in the input pen will not allow overvoting. After the voter has made the correct number of votes, the probe will block for any further voting on the given section. Also, in the embodiment with the button-based voting, the mechanism of the voting apparatus will not accept overvotes, votes that are cast in error, if the voter is pressing OK button to cast a vote after he or she has already voted for that ballot item.

### Voter Verified Printout

As shown in FIG. 1, an optional Printer 36 can be operationally connected to Voting Apparatus 10 in one embodiment. In one embodiment, a thermal paper printer or equivalent prints the votes cast by the current voter. The printer is contained in a locked box and shows the voter his/her votes through a small window. Thus the voter can see the votes he/she has cast printed on paper before leaving. In one embodiment, when a vote is cast it appears on the right part of the display. The vote is also printed by the printer on a piece of paper containing a running list of votes so that the voter can see what votes have been cast on the printer. When the voter is satisfied with the record and confirms his/her votes, the printer resets for the next voter by moving ahead to show blank paper in the small window. The printout serves as an additional record of votes on the corresponding machine.

### Tampering Prevention

In one embodiment of the present invention, there are mechanical locks operated by keys to prevent tampering. These locks are locked at the voting headquarters before the voting apparatus are delivered to the polling places. In one embodiment, the locks are monitored by electronic sensors that record any unwanted intrusion. In one embodiment, one lock locks the IC card drive (which records the results), one locks the optical disc drive (which contains election information to be displayed on screen) and one locks the printer. The IC card and optical disc and printer can be locked at the headquarters before the voting apparatus are delivered to the local polling places. Also, because the CPU onboard contains a simple and limited computer program and accepts only the buttons or probe as input, the risk of it being re-programmed to alter votes is low. In the probe embodiment that generates paper ballots, even if re-programming is performed, any changes can be easily detected by cross-checking the actual ballots.

In one embodiment, possibilities of electronic tampering are further prevented by using a password code for communication between IC card and the CPU and between optical disc and the CPU. The password code ensures the IC card and recorded media cannot be changed or altered. In one embodiment, the IC Card Drive is write-only to prevent any tampering from IC-Card. Also, voting apparatus records the votes in the hard drive and the records can be retrieved to cross check against the results stored on the IC card. Finally, the present invention provides no means of input into the individual unit (other than the probe and button) and allows no interconnectivity between voting apparatus.

### Power

In one embodiment, one battery is used for machine memory and one battery is used for backup in the event of a power failure. It can be appreciated that a number of power sources can be used to provide power supply in the present invention.

### Method of Operation

In one embodiment, the following steps are taken to operate the voting apparatus of the present invention:
1 At the appropriate level, decide on languages to be used for the election.
2. Program ballot (election) information and voting instructions in the chosen languages onto an optical disc.
3. Record and program voice instructions onto optical disc in the chosen languages.
4. Program identification codes onto IC card and optical disc (optional).
5. Turn on Voting Apparatus 18, operating system will start up.
6. Open Security lock 30, insert optical disc into Optical Disc Reader 20 and IC card into IC Card Drive 18. If password codes are used, the voting apparatus will verify password codes and serial numbers on the IC card and the optical disc.

After these steps are performed, in one embodiment of the present invention the voting apparatus will read the IC card and verify the password codes. The voting apparatus will check the optical disc to see that it matches the password codes. The voting apparatus will check all systems automatically and indicate that it is ready.

In one embodiment, the election information (e.g. candidate names, etc.) can be programmed into the apparatus by way of filling out a programming sheet similar to a Scantron sheet and fed into scanner. The election information can thus be programmed into the voting apparatus without requiring workers to g through a complex computer programming process.

After these steps the poll workers can lock the voting apparatus for delivery to polling locations. After the voting apparatus has been delivered to local polling stations, local poll workers will set up the voting apparatus and turn them on.

Local polling workers follow these steps of operation:
1. After the election has been completed, poll workers will unlock and open the voting apparatus and take out the IC card from the IC card drive. The IC card contains a complete record of the votes and undervotes for that machine. Authorized poll workers who know the password code can then read the results with card readers. In the voting apparatus embodiment with probe-based voting, the paper ballot cards should be collected and identified by the number of the machine from which they come. They must be preserved in case they are needed for recounting by optical scanner or by hand.
2. Vote totals can be derived from the IC card (also known as SMARTCARD) records, the ballot card counting and the printer records. These totals can be cross-checked against each other.

Thus, a voting apparatus and method of use are described in conjunction with one or more specific embodiments.

What is claimes is:

1. A voting apparatus, comprising:
a computing unit;
a display;
an input panel further comprising several input buttons;
a computer drive for writing information;
a printer means for recording information; and
a speaker means.

2. A voting apparatus, comprising:
a computing unit;
a display;
an electronic input probe;
a computer drive for writing information; and
a printer means for recording information.
